(19) United States
(12) Patent Application Publication
(10) Pub. No.: US 2024/0039201 A1
(43) Pub. Date: Feb. 1, 2024

(54) Connector

(71) Applicant: Tyco Electronics Japan G.K., Kawasaki-shi (JP)

(72) Inventors: Tsugumi Matsumoto, Shizuoka (JP); Tetsuro Akiguchi, Kakegawa (JP); Yuki Tsutsui, Kawasaki-shi (JP); Seiji Shishikura, Kawasaki-shi (JP); Yusuke Mito, Tochigi Prefecture (JP)

(73) Assignee: Tyco Electronics Japan G.K., Kawasaki-shi (JP)

(21) Appl. No.: 18/360,389

(22) Filed: Jul. 27, 2023

(30) Foreign Application Priority Data
Jul. 27, 2022 (JP) 2022-119130

(51) Int. Cl. H01R 13/436; H01R 13/11

(52) U.S. Cl. CPC H01R 13/4361; H01R 13/11

(57) ABSTRACT

A connector comprises a contact pin, a housing into which the contact pin is inserted, and a retainer. The contact pin includes a contact point portion formed on an end thereof and defining an opening adapted to receive a mating contact, and an engagement portion. The engagement portion is defined at least partially through the contact point portion, and includes a continuous opening formed partially through a side wall of the contact point portion in a height direction and partially through a top wall or a bottom wall of the contact point portion in a width direction. The retainer is insertable into the housing in a direction intersecting the direction of insertion of the contact pin. The retainer is adapted to be inserted into the housing and engage with the engagement portion of the contact pin to secure the contact pin within the housing.

### CROSS-REFERENCE TO RELATED APPLICATIONS

This application claims the benefit of Japanese Patent Application No. 2022-119130, filed Jul. 27, 2022, the whole disclosure of which is incorporated herein by reference.

### FIELD OF THE INVENTION

Embodiments of the present disclosure relate to a connector including a retainer that retains a contact pin inserted into a housing.

### BACKGROUND

Electrical connectors of a type that secure a contact pin with a retainer are known. In these connectors, the retainer is inserted into a housing from a direction intersecting a direction of insertion of the contact pin into the housing to secure the contact pin. In addition to the role of securing the contact pin, this retainer also has serves as an indicator that the contact pin has not been inserted up to a correct position in the housing.

The contact pin includes a contact point portion that includes a contact point that comes into contact with a mating contact, and a wire connecting portion or terminating end connected to a wire. The contact pin is typically formed in a tubular shape so as to surround the contact point. The contact pin is conventionally retained by engaging the retainer with a step difference at a back end of the contact point portion on the wire connecting portion side.

As an increasing tendency of recent years, size reduction is also required in this type of connector. Thus, the contact pin itself needs to be downsized. If the size of the contact pin is reduced, a step difference of a sufficient height cannot be ensured, and thus the retaining function of the retainer may not be ensured. Furthermore, this may cause a change in a height position of the retainer to be relatively small when the contact pin is inserted up to a correct position in the housing compared to when the contact pin is not inserted up to the correct position in the housing. Accordingly, the retainer's function as an indicator may become hindered.

### SUMMARY

According to an embodiment of the present disclosure, a connector comprises a contact pin, a housing into which the contact pin is inserted, and a retainer. The contact pin includes a contact point portion formed on an end thereof and defining an opening adapted to receive a mating contact, and an engagement portion. The engagement portion is defined at least partially through the contact point portion, and includes a continuous opening formed partially through a side wall of the contact point portion in a height direction, and partially through a top wall or a bottom wall of the contact point portion in a width direction. The retainer is insertable into the housing in a direction intersecting the direction of insertion of the contact pin. The retainer is adapted to be inserted into the housing and engage with the engagement portion of the contact pin to secure the contact pin within the housing.

### BRIEF DESCRIPTION OF THE DRAWINGS

The invention will now be described by way of example with reference to the accompanying Figures, of which:

FIG. 1A is an exploded isometric view of a connector of a first embodiment of the present invention.

FIG. 1B is another exploded isometric view of the connector of the first embodiment of the present invention.

FIG. 2A is a top view of a contact pin.

FIG. 2B is a plan view of the contact pin of FIG. 2A.

FIG. 2C is a bottom view of the contact pin of FIG. 2A.

FIG. 2D is a left side view of the contact pin of FIG. 2A.

FIG. 2E is a right side view of the contact pin of FIG. 2A.

FIG. 3 is an isometric view of the contact pin.

FIG. 4A is an isometric view of the connector in a state in which the contact pin is inserted up to a middle position before reaching a normal depth position in the housing.

FIG. 4B is a plan view of the connector of FIG. 4A.

FIG. 4C is a side view of the connector of FIG. 4A.

FIG. 5 is a cross sectional view of the connector in the same state as FIG. 4.

FIG. 6A is an isometric view of a connector in a state in which the contact pin is inserted up to the normal depth position in the housing.

FIG. 6B is a plan view of the connector of FIG. 6A.

FIG. 6C is a side view of the connector of FIG. 6A.

FIG. 7 is a cross sectional view of the connector in the same state as FIG. 6.

FIG. 8A is an isometric view of a contact pin utilized in a connector of a second embodiment of the present invention.

FIG. 8B is another isometric view of the contact pin utilized in the connector of the second embodiment of the present invention.

FIG. 9A is a cross sectional view of the portion of the engagement portion of the contact pin illustrated in FIG. 8.

FIG. 9B is a schematic view illustrating a state in which the retainer is fitted into the engagement portion.

FIG. 10A is an isometric view of a contact pin adopted in a connector of a third embodiment of the present invention.

FIG. 10B is another isometric view of the contact pin adopted in the connector of the third embodiment of the present invention.

FIG. 11A is a cross sectional view of the portion of the engagement portion of the contact pin illustrated in FIGS. 10A and 10B.

FIG. 11B is a schematic view illustrating a state in which the retainer is fitted into the engagement portion.

FIG. 12A is an isometric view of a contact pin adopted in a connector of a fourth embodiment of the present invention.

FIG. 12B is another isometric view of the contact pin adopted in the connector of the fourth embodiment of the present invention.

FIG. 13A is a cross sectional view of the portion of the engagement portion of the contact pin illustrated in FIGS. 12A and 12B.

FIG. 13B is a schematic view illustrating a state in which the retainer is fitted into the engagement portion.

FIG. 14A is an isometric view of a contact pin adopted in a connector of a fifth embodiment of the present invention.

FIG. 14B is another isometric view of the contact pin adopted in the connector of the fifth embodiment of the present invention.

FIG. 15A is a cross sectional view of the portion of the engagement portion of the contact pin illustrated in FIGS. 14A and 14B.

FIG. 15B is a schematic view illustrating a state in which the retainer is fitted into the engagement portion.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

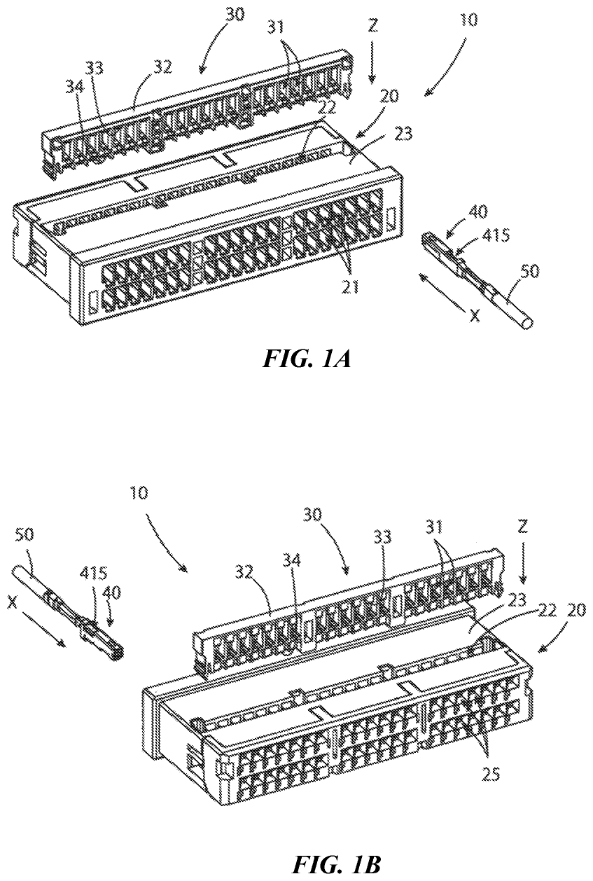

FIGS. 1A and 1B are exploded isometric views of a connector of a first embodiment of the present invention. More specifically, FIG. 1A is an exploded isometric view viewed from a side in which a contact pin is inserted into a housing, and FIG. 1B is an exploded isometric view viewed from a mating surface side facing a mating connector (not shown). As illustrated, a connector 10 includes a housing 20, a retainer 30, and a contact pin 40. A plurality of laterally opened insertion holes 21, into which the contact pins 40 are inserted, are formed in two upper and lower stages of the housing 20. The contact pins 40 are inserted in the direction of an arrow X into each one of the plurality of insertion holes 21. In the illustrated embodiment, only one contact pin 40 is inserted into one of the insertion holes 21. A wire 50 is connected to a back portion in the direction of insertion of the contact pin 40 into the housing 20. The wire 50 is further extended backward, however, only a portion of the front end connected to the contact pin 40 is illustrated.

The housing 20 is formed with an insertion opening 22 opened upward in a slit or channel form. The retainer 30 is inserted into the housing 20 in the direction indicated with an arrow Z into the insertion opening 22. Only one row of through-holes 31, through which the contact pin 40 passes through, is formed in the retainer 30. A dimension in the vertical direction of the through-hole 31 is larger than a vertical dimension of the portion of the contact pin 40 that has passed through the through-hole 31. The retainer 30 is movable in the vertical direction in a state in which the contact pin 40 is passed through the through-hole 31.

The retainer 30 is inserted into the housing 20 up to a half-mating position at which an upper surface 32 of the retainer 30 projects out from the upper surface 23 of the housing 20 before the insertion of the contact pin 40. Thereafter, the contact pin 40 may be inserted into the insertion hole 21 of the housing 20. The contact pin 40 inserted into the insertion hole 21 of the upper stage, among the contact pins inserted into the insertion holes of the two upper and lower stages, further passes through the through-hole 31 of the retainer 30. In distinction, a contact pin 40 inserted to the insertion hole 21 of the lower stage passes beneath the lower side of the retainer 30.

Thus, after the contact pins 40 are inserted into each of the insertion holes 21, the retainer 30 is pushed down to a complete mating position at which the upper surface 32 of the retainer is in flush with the upper surface 23 of the housing 20. As a result, the retainer 30 engages with all the contact pins 40 of the two upper and lower stages, and the contact pins are retained within the housing 20.

FIG. 1B illustrates mating openings 25 formed in the housing 20. The mating openings 25 are in communication with the insertion holes 21 shown in FIG. 1A. When the connector 10 is mated with the mating connector (not shown), a male-type contact pin held by the mating connector is inserted into the mating opening 25, and comes into electrical contact with the contact pin 40 arranged within the housing 20.

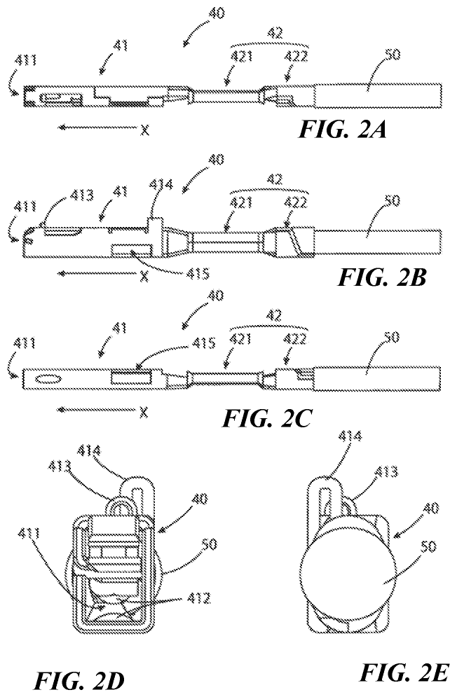

FIG. 2A is a top view, FIG. 2B is a plan view, FIG. 2C is a bottom view, FIG. 2D is a left side view, and FIG. 2E is a right side view of the contact pin 40. FIGS. 2D and 2E are enlarged as compared with FIGS. 2A to 2C. FIG. 3 is an isometric view of the contact pin 40. FIG. 3 is enlarged to a dimension intermediate of FIGS. 2A-2C and FIGS. 2D and 2E.

With reference to FIGS. 2A-2E and 3, the contact pin 40 has a contact point portion 41 provided on a front side thereof and extending in the direction of insertion indicated by the arrow X. The contact pin 40 further includes a wire connecting portion 42 provided on the back side thereof. The contact point portion 41 is an element that comes into contact with the mating contact provided on the mating connector (not shown). The contact point portion 41 has an opening 411 into which the male-type mating contact is inserted at the front end in a direction opposite the insertion indicated by the arrow X. Interiorly, the contact point portion 41 has a contact point 412 that comes into contact with the mating contact. The contact point portion 41 is formed in a substantially rectangular tubular shape extending in the direction of insertion and surrounding the contact point 412.

Further, the contact point portion 41 is provided with a lance abutting portion 413 and a jig abutting portion 414. The lance butting portion 413 is a portion to which a distal end of a lance 24 (see FIG. 7) formed in the housing 20 is abutted when the contact pin 40 is inserted to the housing 20. This abutting causes the contact pin 40 to be temporarily captured for retaining. The jig butting portion 414 is a portion to which a jig (not shown) is abutted when the contact pin 40 is pushed into the housing 20. The jig butting portion 414 has a function of preventing the contact pin 40 from being improperly inserted in a vertically inverted orientation when being inserted into the housing 20.

The contact point portion 41 has an engagement portion 415 provided at a middle position and extending in the direction of insertion indicated by the arrow X of the contact point portion 41. As illustrated in FIGS. 2B and 2C, the engagement portion 415 has a shape opened to the inside and the outside of the substantially rectangular tubular shape across two sides of the contact point portion 41 that come into contact with each other (i.e., two continuous sides). With the retainer 30 is inserted up to the half-mating position with respect to the housing 20, the contact pin 40 may be fully-inserted into the housing. When the retainer 30 is further inserted up to the complete mating position within the housing 20, the retainer enters or engages with the engagement portion 415, so that the contact pin 40 is strongly retained in the housing.

The wire connecting portion 42 has a core wire pressure bonding portion 421 and an exterior covering pressure bonding portion 422. The wire 50 is connected to the wire connecting portion 42. The wire 50 includes a conductive core wire (not shown) and an insulating exterior covering that covers the core wire. The exterior covering of a distal end portion of the wire 50 is peeled and exposed, and is pressure bonded and connected to the core wire pressure bonding portion 421. In addition, the exterior covering of the wire 50 is pressure bonded to the exterior covering pressure bonding portion 422.

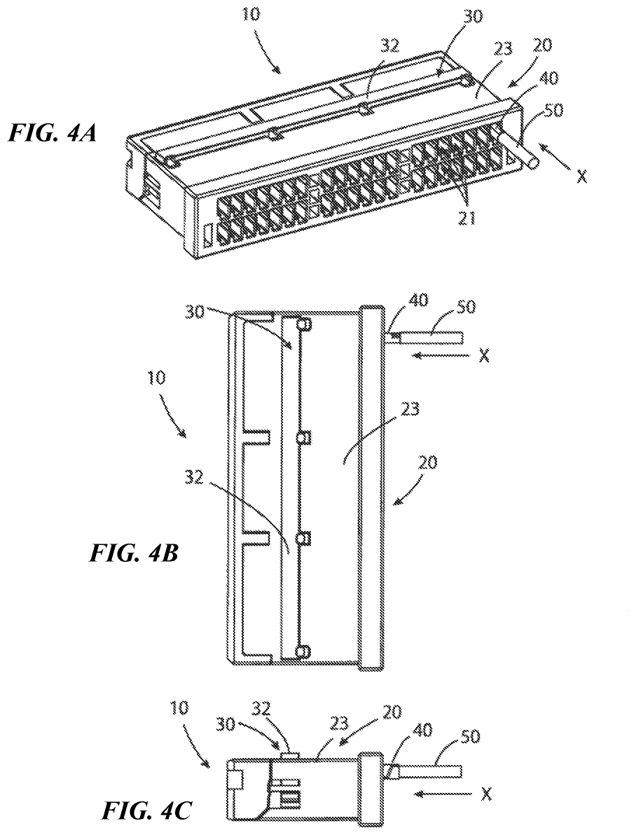

FIG. 4A is an isometric view, FIG. 4B is a plan view, and FIG. 4C is a side view of a connector in a state in which the contact pin is inserted up to a middle or intermediate depth position within the housing. Furthermore, FIG. 5 is a cross sectional view of the connector in the same state as FIGS. 4A-4C. The cross sectional view is enlarged as compared with FIGS. 4A-4C.

In a state in which the contact pin 40 is inserted up to the middle depth position shown in FIGS. 4A-4C and 5, the retainer 30 cannot enter the engagement portion 415 of the contact pin. As a result, the upper surface 32 of the retainer 40 projects out from the upper surface 23 of the housing 20. Thus, it can be recognized by a user that the contact pin 40 is not inserted up to the normal or fully inserted depth position. In order to avoid false recognition, the projection amount or distance of the retainer 30 from the housing 20 is preferably large. In the present embodiment, the engagement portion 415 formed in the contact point portion 41 of the contact pin 40 has a depth selected such that a stroke between the half-mating position and the complete mating position of the retainer 30 is sufficiently large. As a result, a sufficient projection distance of the retainer 30 is realized and false recognition can be avoided. Furthermore, in order to more easily discern whether the retainer 30 is in the half mating position or at the complete mating position, the retainer is preferably formed with a conspicuous color different from the housing 20.

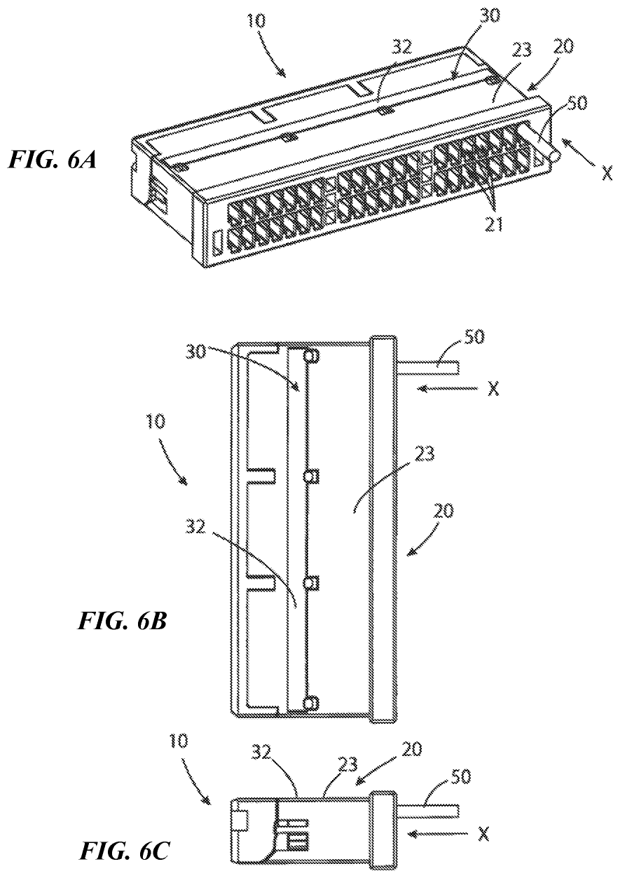

FIG. 6A is an isometric view, FIG. 6B is a plan view and FIG. 6C is a side view of a connector in a state in which the contact pin is inserted up to the normal depth position in the housing. Furthermore, FIG. 7 is a cross sectional view of the connector in the same state as FIGS. 6A-6C. This cross sectional view is enlarged as compared with FIGS. 6A-6C.

With reference to FIGS. 6A-6C and 7, when the contact pin 40 is inserted up to the normal depth position, the engagement portion 415 of the contact pin 40 overlaps the through-hole 31 of the retainer 30. Thus, the retainer 30 in the half mating position can be pushed down into the complete mating position. When the retainer 30 is pushed down to the complete mating position, the wall portion 33 on the upper side of the through hole 31 of the retainer is fitted into the engagement portion 415 of the contact pin 40, and the contact pin is strongly retained within the housing 20. Furthermore, when pushed down to the complete mating position, the upper surface 31 of the retainer 30 becomes flush with the upper surface 23 of the housing 20. It is recognized that the contact pin 40 is inserted up to the normal depth position by confirming that these surfaces are flush or level with one another.

The insertion hole 21 of the housing 20 is formed in two upper and lower stages, whereas the through-hole 31 of the retainer 30 is formed only in one stage in the vertical direction corresponding to the insertion hole 21 of the upper stage. The wall portion 34 on the lower side of the through hole 31 of the retainer 30 pushed down into the engagement portion 415 of the contact pin 40 inserted to the insertion hole 21 of the lower stage to the complete mating position. In this way, the contact pin 40 is strongly retained similarly to the contact pin inserted to the insertion hole 21 of the upper stage.

In the following description of each additional embodiment of the present disclosure, only the contact pin 40 and the retainer 30 will be illustrated and described. Furthermore, in the following description of each embodiment, the same reference numerals and names as the reference numerals and names used in the first embodiment will be utilized, regardless of any difference in shape.

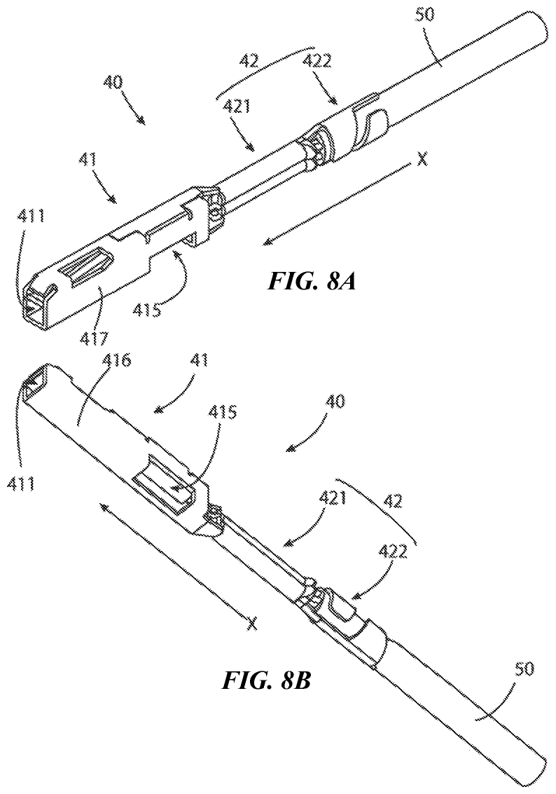

FIGS. 8A and 8B are isometric views of a contact pin 40 adopted in a connector of another embodiment of the present invention. FIGS. 8A and 8B are isometric views when the contact pin 40 is viewed from different viewpoints. The contact pin 40 of the second embodiment illustrated in FIGS. 8A and 8B is distinct from the contact pin 40 of the first embodiment illustrated in FIGS. 2A-2E in various aspects, such as the shape of the exterior covering pressure bonding portion 422. However, the engagement portion 415 substantially follows the shape of the engagement portion 415 of the contact pin 40 of the first embodiment.

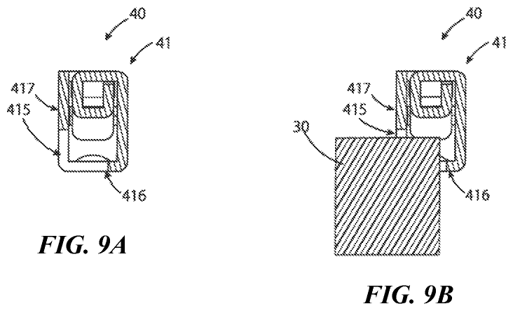

FIG. 9A is a cross sectional view of the portion of the engagement portion of the contact pin 40 illustrated in FIGS. 8A and 8B, and FIG. 9B is a schematic view illustrating a state in which the retainer 30 is fitted into the engagement portion. In this embodiment, the engagement portion 415 is formed across two sides, the side 416 on the lower side and the left side 417, as shown in the cross-section illustrated in FIG. 9A of the contact point portion 41 having a substantially rectangular cross sectional shape. As shown in FIG. 9B, the retainer 30 is fitted into the engagement portion 415 formed across the two sides 416, 417.

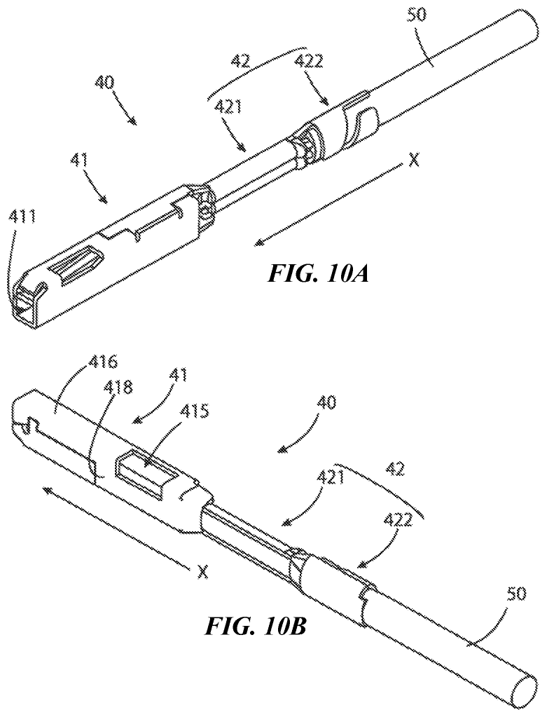

FIGS. 10A and 10B are isometric views of a contact pin 40 adopted in a connector of another embodiment of the present invention. FIGS. 10A and 10B are isometric views when the contact pin 40 is viewed from different viewpoints from each other. According to the contact pin 40 of the embodiment illustrated in FIGS. 10A and 10B, the position of the engagement portion 415 is distinct compared with the contact pin 40 of the second embodiment illustrated in FIGS. 8A and 8B.

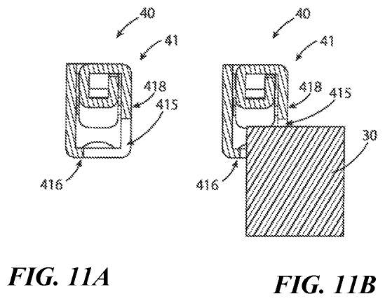

FIG. 11A is a cross sectional view of the portion of the engagement portion 415 of the contact pin 40 illustrated in FIGS. 10A and 10B, and FIG. 11B is a schematic view illustrating a state in which the retainer 30 is fitted into the engagement portion. In this embodiment, the engagement portion 415 is formed across two sides, the side 416 on the lower side and the side 418 on the right side, as shown in the cross-section illustrated in FIG. 11A of the contact point portion 41 having a substantially rectangular cross sectional shape. As shown in FIG. 11B, the retainer 30 is fitted into the engagement portion 415 formed across the two sides 416, 418.

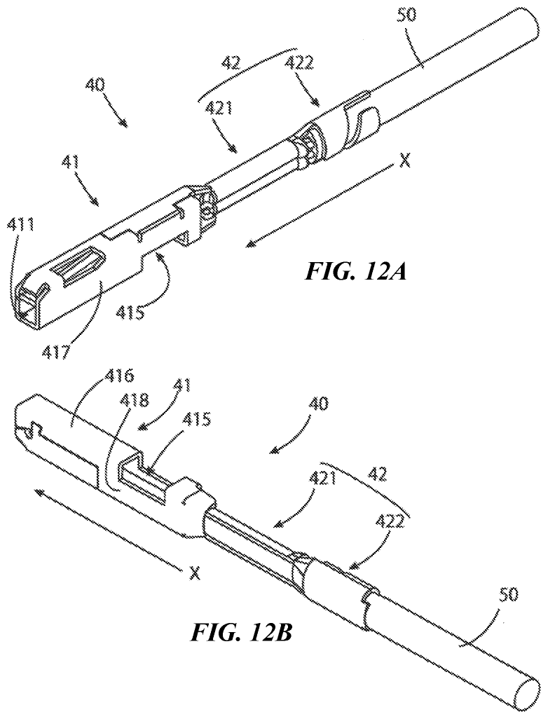

FIGS. 12A and 12B are isometric views of a contact pin 40 of another embodiment of the present invention. FIGS. 12A and 12B are isometric views when the contact pin 40 is viewed from different viewpoints. The contact pin 40 of the embodiment illustrated in FIGS. 12A and 12B includes an engagement portion 415 having a shape distinct from that of the contact pin 40 of the second embodiment illustrated in FIG. 8 and the embodiment illustrated in FIG. 10.

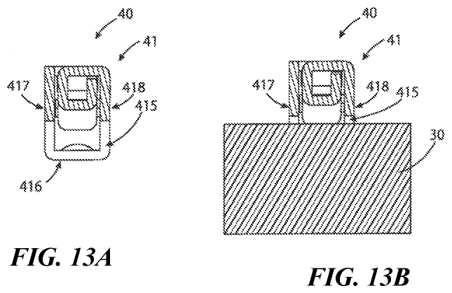

FIG. 13A is a cross sectional view of the portion of the engagement portion 415 of the contact pin illustrated in FIGS. 12A and 12B and FIG. 13B is a schematic view illustrating a state in which the retainer 30 is fitted into the engagement portion. In this embodiment, the engagement portion 415 is formed across three sides, the side 417 on the left side, the side 416 on the lower side and the side 418 on the right side, in the cross-section illustrated in FIG. 12A of the contact point portion 41 having a substantially rectangular cross sectional shape. As shown in FIG. 13B, the retainer 30 is fitted into the engagement portion 415 formed across the three sides.

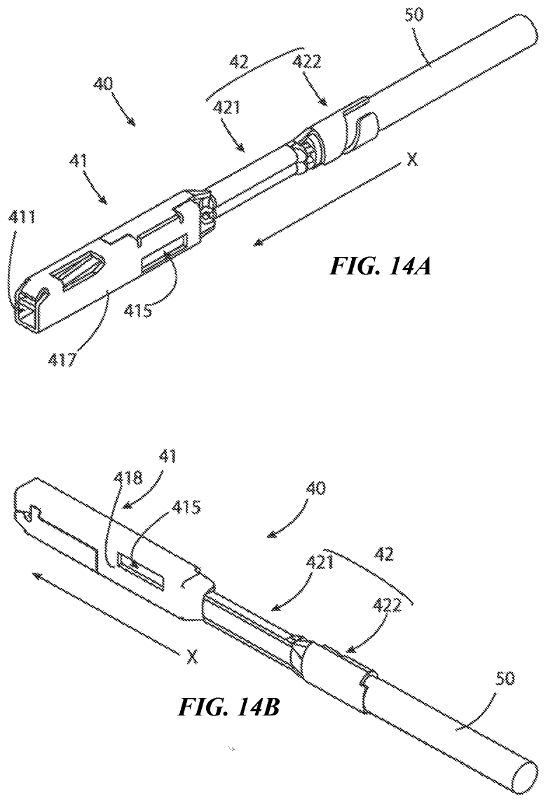

FIGS. 14A and 14B are isometric views of a contact pin 40 adopted in a connector of another embodiment of the present invention. FIGS. 14A and 14B are isometric views when the contact pin 40 is viewed from different viewpoints. The contact pin 40 of the embodiment illustrated in FIG. 14 includes an engagement portion 415 having a shape distinct from that of the contact pin 40 of each embodiment illustrated above.

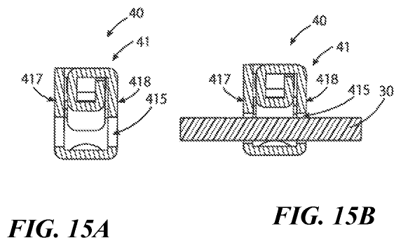

FIG. 15A is a cross sectional view of the portion of the engagement portion 415 of the contact pin 40 illustrated in FIGS. 14A and 14B, and FIG. 15B is a schematic view illustrating a state in which the retainer 30 is fitted into the engagement portion. In this embodiment, the engagement portion 415 is formed as a through-hole passing through two sides of the side 417 on the left side and the side 418 on the right side in the cross-section illustrated in FIG. 14A of the contact point portion 41 having a substantially rectangular cross sectional shape. As shown in FIG. 15B, the retainer 30 is fitted into the engagement portion 415 so as to pass through the through-hole.

The engagement portion 415 in each embodiment described above has the retainer 30 fitted to the inner side of the contact point portion 41 at the middle position in the direction of insertion indicated by the arrow X of the contact point portion of the contact pin 40. Thus, the stroke between the half mating position and the complete mating position of the retainer 30 can be sufficiently large, and the retainer can sufficiently retain the contact pin 40 and play a sufficient role as an indicator that the contact pin has been inserted up to the normal position.

Furthermore, the engagement portion 415 in each embodiment described above is formed across a plurality of sides. Thus, the contact pin 40 can be further strongly retained as compared to an engagement portion 15 comprising only a hole formed only in one side of the contact point portion 41 having a substantially rectangular shape and the retainer 30 has a shape that comes into contact with only the one side.

The connector 10 of a type in which the contact pin 40 is inserted into two upper and lower stages in the housing 20 has been described, but the number of stages or rows of the contact pins inserted to the housing may be one stage or may be three or more stages, and the present invention can be applied to various types of connectors.

The connector 10 includes contact pins 40 of a type to which the wire 50 is pressure bonded and connected as described above. However, the present invention is not limited to this method of connecting the wire and the contact pin, and other forms may be used (e.g., soldering).

In addition, those areas in which it is believed that those of ordinary skill in the art are familiar, have not been described herein in order not to unnecessarily obscure the invention described. Accordingly, it has to be understood that the invention is not to be limited by the specific illustrative embodiments, but only by the scope of the appended claims.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of the elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A connector comprising:
a contact pin, including:
a contact point portion formed on a front end of the contact pin and defining an opening adapted to receive a mating contact;
a wire connecting portion formed on a back end of the contact pin and adapted to connect to a wire; and
an engagement portion defined between an open end of the contact point portion and the wire connecting portion;
a housing into which the contact pin is inserted in an insertion direction; and
a retainer insertable into the housing in a direction intersecting the direction of insertion of the contact pin, the retainer adapted to be inserted into the housing and engage with the engagement portion of the contact pin to secure the contact pin within the housing.

2. The connector according to claim 1, wherein the engagement portion has a shape opened to the inside and outside of the contact point portion.

3. The connector according to claim 2, wherein the contact point portion has a substantially rectangular tubular shape, and the engagement portion has a shape opened to the inside and the outside of the tubular shape across two sides that come into contact with each other.

4. The connector according to claim 2, wherein the contact point portion has a substantially rectangular tubular shape, and the engagement portion has a shape opened to the inside and the outside of the tubular shape across three sides of the substantially rectangular shape.

5. The connector according to claim 1, wherein the engagement portion has a shape passing through the contact point portion.

6. The connector according to claim 1, wherein the contact point portion includes a first side wall and a top wall.

7. The connector according to claim 6, wherein the engagement portion is defined by a continuous opening formed through the first side wall and the top wall.

8. The connector according to claim 7, wherein the contact point portion has a substantially rectangular cross section.

9. The connector according to claim 7, wherein the opening extends only partially through the first side wall in a height direction.

10. The connector according to claim 6, wherein the contact point portion further includes a second side wall opposite the first side wall.

11. The connector according to claim 10, wherein the engagement portion does not extend into the second side wall.

12. The connector according to claim 10, wherein the engagement portion is defined by a continuous opening formed through the first side wall, the second side walls and the top wall.

13. The connector according to claim 12, wherein the engagement portion extends only partially through the first side wall and the second side wall in a height direction.

14. The connector according to claim 1, wherein the contact point portion includes a first side wall and a bottom wall, and the engagement portion is defined by a continuous opening formed through the first side wall and the bottom wall.

15. The connector according to claim 14, wherein the contact point portion further includes a second side wall opposite the first side wall, and the engagement portion does not extend into the second side wall.

16. The connector according to claim 1, wherein the contact point portion includes two opposing walls, and the engagement portion is defined by an opening extending through both of the opposing walls.

17. A connector comprising:
a contact pin, including:
a contact point portion formed on an end of the contact pin and defining an opening adapted to receive a mating contact, the contact point portion including a plurality of walls; and
an engagement portion defined at least partially through the contact point portion, the engagement including an opening formed through at least two walls of the plurality of walls;
a housing into which the contact pin is inserted in an insertion direction; and
a retainer insertable into the housing in a direction intersecting the direction of insertion of the contact pin, the retainer adapted to be inserted into the housing and engage with the engagement portion of the contact pin to secure the contact pin within the housing.

18. The connector according to claim 17, wherein the contact point portion has a substantially rectangular cross section and the plurality of walls include a first side wall, a second side wall, a top wall and a bottom wall, and the engagement portion is formed through at least two continuous ones of the first side wall, the second side wall, the top wall and the bottom side wall.

19. The connector according to claim 18, wherein the engagement portion is formed through at least three continuous ones of the first side wall, the second side wall, the top wall and the bottom side wall.

20. A contact pin, comprising:
a contact point portion formed on a front end of the contact pin and defining an opening adapted to receive a mating contact, the contact point portion including at least three side walls; and
an engagement portion defined at least partially through the contact point portion, the engagement portion including an opening formed through at least two of the three side walls.
